(19) United States
(12) Patent Application Publication
(10) Pub. No.: US 2008/0192008 A1
(43) Pub. Date: Aug. 14, 2008

(54) Magnetically coupled fader controller for electronic display

(76) Inventor: Denny Lee Jaeger, Oakland, CA (US)

Correspondence Address: ZIMMERMAN & CRONEN, LLP, 1330 BROADWAY, SUITE 710, OAKLAND, CA, 94612-2506, US

(21) Appl. No.: 11/986,871

(22) Filed: Nov. 27, 2007

Related U.S. Application Data
(60) Provisional application No. 60/889,821, filed on Feb. 14, 2007.
(60) Provisional application No. 60/900,590, filed on Feb. 9, 2007.
(60) Provisional application No. 60/963,939, filed on Aug. 8, 2007.

(51) Int. Cl. G06F 1/16; G06F 3/033

(52) U.S. Cl. 345/161; 340/10.1

(57) ABSTRACT

A control device provides a transparent overlay for an electronic display, the overlay having at least one closed channel formed therein to accommodate a fader tongue that is translatable therealong. A fader cap has no mechanical attachment to the fader tongue but includes a magnet, whereby the fader cap may be placed onto the outer surface of the overlay to establish a magnetic coupling to a magnet in the fader tongue for mutual translation purposes. Wheels on the fader cap maximize the glide of the fader cap and constrain translation so that the axis of travel of the wheeled fader cap is aligned with the underlying channel. The fader cap may include a touch detecting switch, and RF circuit for communicating the touch signal to a host computer for feedback control of the associated fader tongue.

### CROSS-REFERENCE TO RELATED APPLICATIONS

This application claims the priority benefit of the filing dates of the following Provisional Applications: 60/860,929, filed Nov. 24, 2006; 60/889,821, filed Feb. 5, 2007; 60/900,590, filed Feb. 9, 2007; and 60/963,939, filed Aug. 8, 2007.

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to devices for controlling electrical apparatus and more particularly to devices of his kind which are disposed at the face of an electronic display screen which displays changeable information pertinent to operation of the control device.

2. Description of Related Art

U.S. Pat. No. 6,642,919 discloses a control device for an electronic apparatus that is operatively connected to an electronic display, whereby the display delivers information to a user and interacts with a control device to enable user inputs to the electronic apparatus. The control device includes a fader having a tongue which slides along a channel formed in a plastic or glass sheet that overlays a portion of the display. It further describes a rotary gear attached to the tongue, and a motor that is attached to the rotary gear to drive the fader tongue in and out of the channel in the glass or plastic sheet. In this arrangement a fader cap projects upwardly from the channel at the distal end of the fader tongue, whereby a user may move the fader cap manually and change an input to the electronic apparatus. The motor may also be actuated by the electronic apparatus to drive the tongue reciprocally and selectively along the channel to port.

### BRIEF SUMMARY OF THE INVENTION

The present invention generally comprises control devices for use with an electronic device, and represent improvements to the technology shown in U.S. Pat. No. 6,642,919, issued Nov. 4, 2003, and similar prior art. As in the prior art, the invention provides a transparent overlay for an electronic display, the overlay having at least one channel formed therein to accommodate a fader tongue that is translatable therealong. The channel extends to an edge of the overlay, where a sensor detects the length of fader tongue that has been extended into the channel, and generates a corresponding control signal to the electronic apparatus.

In one aspect, the channel is sealed within the overlay, and the control device includes a fader cap that is not physically connected to the fader tongue. Rather, the fader cap is provided with a magnet, and the fader tongue includes a distal end that is likewise provided with a magnet, whereby the fader and fader tongue may be coupled by magnetic attraction. As a result, a user may place the fader cap onto the outer surface of the overlay, in registration with the distal end of the fader tongue, and establish a magnetic coupling therebetween. Thereafter, the user may push the fader cap along the axis of the channel therebelow to urge the fader tongue to extend or retract and generate a changeable control signal in the electronic apparatus. The fader cap and the fader tongue may be provided with gliding surfaces to enhance ease of motion.

In another embodiment of this invention, the fader tongue moves below the overlay glass and is not inside the glass in a channel. The fader cap is magnetically coupled to the distal end of the fader cap which moves under the overlay glass as the fader cap is moved on top of the overlay glass.

The fact that the transparent overlay has a smooth continuous outer surface devoid of any channels or slots is a distinct advantage over the prior art, which required an open slot for the fader cap to be mechanically joined to the fader tongue. The smooth contiguous surface is easier to keep free of dust and dirt which would otherwise diminish the visualization of the electronic display through the transparent overlay. And the fader tongue mechanism is isolated from external sources of dirt and contamination, promising better performance and greater longevity.

In another aspect, the invention provides wheels for the fader cap to maximize the glide of the fader cap on the outer surface of the overlay. The wheels furthermore provide a monodirectional characteristic to the fader cap, so that when the axis of travel of the wheeled fader cap is aligned with the underlying channel, the fader cap will tend to translate along the channel axis and remain magnetically coupled to the distal end of the fader tongue. Likewise, the fader tongue may be provided with wheels at the distal end to support the magnet secured thereto, and to minimize gliding friction for the tongue.

To enhance the monodirectional effect, the outer surface of the overlay may be provided with shallow parallel grooves that are aligned with the underlying channel and are spaced apart to engage the wheels of the fader cap. The wheels of the fader cap may be shaped or inclined to optimize engagement in the grooves, whereby the fader cap is constricted to translate along the grooves and thus disposed to maintain magnetic alignment and coupling with the distal end of the fader tongue within the channel therebelow.

In any of the embodiments above (or those to be described below), the fader tongue may be driven by a motor located adjacent to the edge of the overlay assembly. The motor may be connected to a sprocket wheel or to pressure rollers or wheels that move the tongue by pressure engagement on the tongue's top surface, bottom surface or both. Either type of mechanical engagement moves the tongue, so that the electronic apparatus may position the fader tongue and the coupled fader cap that represents a current setting or stored setting for the respective control parameter. In addition, the sensors that detect the tongue extension in the channel may be shaft encoders connected to the sprocket wheel, pressure wheels, or optical sensors that detect angular displacement of the sprocket wheel or pressure wheel(s), or optical sensors that detect the linear translation of the tongue. Other sensor arrangements known in the prior art may also be used. Note: the pressure wheels may be fashioned like the capstan on a tape recording machine or be presented as one or more pressure rollers that are pressed against the fader tongue to enable a motor to move it.

A further aspect of the invention comprises methods for detecting a finger touch on a fader cap disposed on the upper surface of the overlay assembly. This touch detection may be used, for example, to activate or defeat the drive motor associated with the fader tongue. In one embodiment of this aspect the fader cap is provided with an RFID circuit that transmits a touch signal to a receiver associated with the electronic device. Likewise, a coil embedded in the fader cap may be activated by the user touching the fader cap, and a signal is transmitted to a similar coil in the fader tongue, which transmits the signal through a conductor in the tongue to the electronic apparatus to control the motor.

In either the RFID or coil embodiments above, a further function of the fader cap circuit comprises sensing the direction of push of the finger touch along the axis of the fader tongue. This directional signal (advance or retract tongue) may be used by the electronic apparatus to drive the motor to move the fader tongue (and the magnetically coupled fader cap) in the direction desired by the user. The advantage of this arrangement is that the user does not need to overcome the frictional and mechanical resistance of the fader tongue in its channel in the overlay assembly. Rather, the directional signal will drive the tongue in the direction indicated by the user's touch, making for a smoother and more intuitive operation of the fader cap.

In another embodiment an encoder senses very slight motion in the fader tongue. This may be as accurate as 20,000 points per inch. Thus a finger touch can be detected with no electronic devices in the fader cap. The detection is made by an encoder that reads incremental revolutions of the motor. When a finger touch is made on a moving fader, the motor's encoder detects a slight motion (or resistance) caused by the finger touch and releases the motor, thereby permitting the user to mechanically move the fader tongue without interference form the motor. When the finger is removed the motor's encoder senses no resistance to the motor's movement of the fader tongue and thereby re-engages the motor to control the motion of the fader tongue.

Another aspect of the invention involves enhanced magnetic coupling between the fader cap and the associated fader tongue within the channel in the transparent overlay. It is observed that a single magnet in the fader cap may engage the opposite pole(s) of a single magnet in the fader tongue, but the primary coupling is in the vertical direction (normal to the outer surface of the overlay). There is little coupling in the lateral (shear) direction, and thus there is a non-insignificant possibility that the fader cap will be moved laterally away from the axis of the fader tongue, resulting in decoupling of the magnetic adhesion therebetween. The signal input from the user is thus interrupted or is at least not consistent as a result of the fader tongue slipping against the fader cap.

The enhanced magnetic coupling includes a plurality of magnets disposed in the fader cap and forming a predetermined array of north and south poles. A similar array of magnets is disposed in the fader tongue, and provided with an inverse polar distribution, so that the fader magnets and fader tongue magnets are aligned in opposed confrontation when the fader is aligned with the distal end of the fader tongue. The individual magnets exert a strong tensile attraction, but more importantly they resist lateral misalignment of the fader and fader tongue by exerting a lateral repulsion force when the fader cap begins to move laterally off-axis. Thus the user is urged by the “feel” of the magnetic interaction to push the fader cap generally along the axis of the channel that encloses the fader tongue that is magnetically coupled to the fader cap.

The advantages of this approach include the following:
1) The fader caps float over a smooth unbroken sheet of material, e.g., glass, plastic and other suitable transparent materials or graphite, metal and other opaque or semi-opaque materials. In all cases, no dirt, dust, grease, liquids, etc., can get into the fader tongue because the fader tongue is enclosed inside or below a material, like glass or plastic.
2) This fader design permits a fader to be operated over a flat panel display. Thus the flat panel display can be used to provide graphical controls and indicators and indicia for operating the fader, like switches, meters, fader scalings, associated devices, assignments, remote control, automation and more. Furthermore, operating a mechanical fader over a flat panel display permits the fader to be configured by changing the graphics displayed adjacent to the mechanical fader on the flat panel display. Furthermore, operating a fader or knob or joystick over a flat panel display supports three types of automation: (1) automation of moves made with the devices, (2) automation of the indicia and other graphical data that enables or supports the operation of the physical devices, and (3) automation of the function of the devices. So a fader, for instance, could be a volume control one moment and then become a pan control or lighting control the next moment, all controlled by automation data.
3) This fader design permits a mechanical fader to be motorized while being operated over a flat panel display.
4) The use of a magnetic encoder permits the fader to have an accuracy beyond that of commercially available motorized faders. For example, a 9 bit magnetic encoder used for this fader design will give a user of this fader 6000 separate positions per inch.
5) Since this fader is a mechanical device, its operation is very fast and a large number of these faders can be operated at the same time without cumulative time delays in their real time operation.
6) The fader is inexpensive to build as there are no electrical components in the fader cap.
7) Fader caps can be of different colors to designate different operations. Changing fader caps is as easy as placing a new fader cap over any given fader tongue.
8) Fader caps can be removed from the surface of the overlay glass or other suitable material and the fader will still operate via motor control.
9) The fader channels and fader tongues can be transparent so all parts of the fader track and tongue (except for the fader magnet array) can be seen through, for instance, to graphics displayed on a flat panel display below the fader tongues.
10) By having multiple rows of magnets, the amount of the lateral force required to move the fader cap perpendicular to the fader tongue is increased. Three rows of magnets could be used instead of two or even more rows, depending upon the desired amount of force desired to break the coupling between the fader cap's magnet array and fader's tongue's magnet array.
11) By using bearings or wheels on the fader cap and on the end of the fader tongue, the vertical magnetic force can be increased without increasing the friction required to overcome to move the fader along its path. The more freely the bearings move, the more they dissipate the friction of increased magnetic coupling.

Furthermore, it should be noted that the distance between the magnets in each of the magnet arrays (that of the fader cap and that of the fader tongue) may be greater than the distance that the magnet array of the fader cap is from the magnet array of the fader tongue.

In all of the embodiments described above, the fader tongue may be fabricated of a thin, flexible belt formed of transparent plastic material, in order to maximize the visualization of the electronic display through the overlay assembly. The belt may be provided with rack teeth arrayed along one edge of the belt, and the drive motor is provided with a corresponding pinion gear to engage the rack teeth and drive the belt longitudinally. Or the belt may be engaged by pressure rollers either pressing on it top, top and bottom surfaces, or on its sides. By eliminating the teeth, the fader's operation may be smoother.

Alternatively, the tongue may be formed of a chain of links formed of transparent plastic material. In this case the motor is connected to a sprocket wheel, as described above, with sprocket teeth to engage the links of the chain, so that the motor may drive the tongue longitudinally in the channel. Note that the limited height of the channel prevents the chain from buckling or doubling, assuring linear longitudinal movement in the channel.

### BRIEF DESCRIPTION OF THE DRAWING

FIGS. 1 and 2 are a partial plan layout and a partial cross-sectional elevation of a prior art apparatus described in U.S. Pat. No. 6,642,919.

FIG. 3 is a cross-sectional elevation of an exploded view of the overlay panel assembly of the present invention.

FIG. 4 is a cross-sectional elevation of the magnetically coupled fader controller of the present invention.

FIG. 5 is a cross-sectional elevation as in FIG. 4, showing a further embodiment of the fader cap.

FIGS. 6 and 7 are a bottom view and side elevation, respectively, of a further embodiment of the fader cap of the invention.

FIG. 8 is a bottom view of a further embodiment of the tongue tip assembly corresponding to the fader cap of FIGS. 6 and 7.

FIG. 9 is an enlarged perspective view of the fader cap assembly and fader tongue assembly of a further embodiment of the invention.

FIG. 10 is a perspective view of one embodiment of the fader tongue drive mechanism of the present invention.

FIG. 11 is a block diagram of an RFID system for detecting and transmitting a touch event from a fader cap.

FIG. 12 is a block diagram of an RFID power transmission arrangement to the fader cap.

FIG. 13 is a block diagram depicting a plurality of magnetically coupled fader controllers, an electronic display associated with the controllers, a host computer, and a data gathering arrangement for transmitting fader tongue movement and fader cap touch data to the host computer.

FIGS. 14A and 14B are a bottom view of a further embodiment of the magnet arrangement in a fader cap; and a magnified partial cross-sectional elevation of the fader cap and is associated fader tongue magnetic structure.

### DETAILED DESCRIPTION OF THE INVENTION

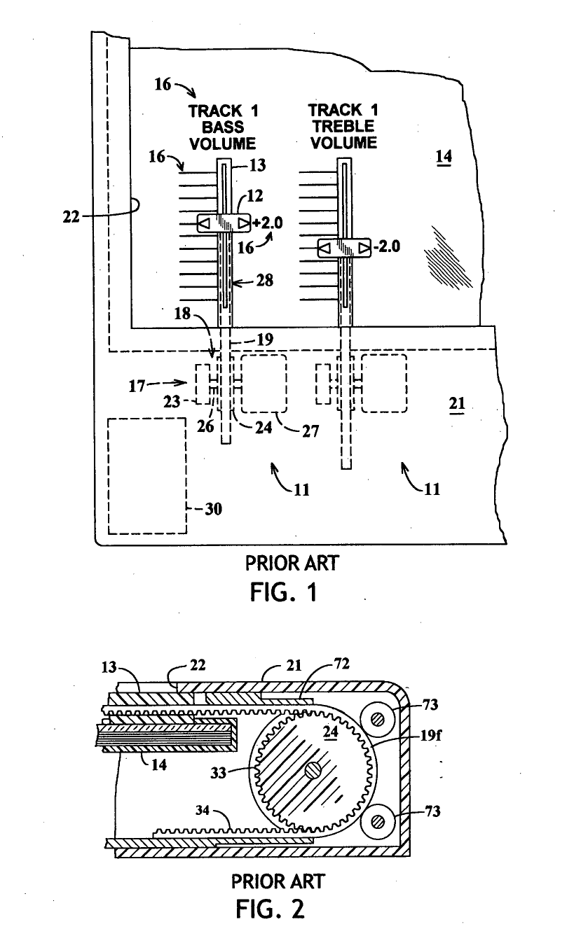

The present invention generally comprises improved control devices for use with electronic apparatus that provide a display screen for interaction with a user. The prior art is exemplified in U.S. Pat. No. 6,642,919, issued Nov. 4, 2003. With regard to FIGS. 1 and 2, it provides control devices 11 of the type in which a fader cap or other movable member 12 is slidable along a track 13 to vary an electrical control signal. In control devices 11 which embody the invention, the movable member 12 and at least a portion of the track 13 are disposed at the face of an electronic display screen 14 which displays graphics 16, such as labels, setting markings or icons for example, that are pertinent to the operation of the control device. Disposition of the movable member 12 and track 13 at the face of the screen 14 enables graphics 16 to be displayed at locations which are adjacent to or very close to those components when that is desirable. The graphics 16 may change during different stages of operation of the control device 11 such as where the same control device is used to control more than one function of the controlled apparatus. The control devices 11 include control signal producing means 17 for producing the control signal in electrical form and for varying the signal in response to movement of the movable member 12. The control signal producing means 17 is disposed adjacent an edge of the screen at an off screen location 18. The movable member 12 is linked to the off screen components by an elongated slidable tongue 19 which extends along the track 13 and outward from an edge of the display screen 14.

The display screen 14 of this example is situated within a housing 21 and the image display area of the screen is viewable through a window 22 in the housing. The control signal producing means 17 are situated within a portion of the housing 21 that is sufficiently extensive to accommodate to the outward travel of tongue 19 from the edge of display screen 14. The tongue 19 of this embodiment is formed of rigid or semi-rigid material. In an alternate embodiment to be hereinafter described the tongue is flexible and enables a reduction in the size of the housing 21. The control signal producing means 17 includes a signal varying component 23, which is a rotary potentiometer in this example, that outputs an electrical signal that is varied by turning of a rotary gear 24 which is coupled to the potentiometer by a shaft 26. Sliding movement of the tongue 19 turns the gear 24. The control devices 11 of this example are of the motorized fader type in which an electrical motor 27 is coupled to shaft 26. Fader motors 27 of the known kind can, reproduce a sequence of movements of the movable member 12 that is initially established by manual manipulation of the member. The motor 27 is an optional component that is not needed in many uses of the control devices 11.

In FIG. 2, a first tongue guide 72 is linear and extends along the tongue 19f only to the point where the tongue begins to engage gear 24. Rotatable tongue tensioning rollers 73 are positioned to bear against the portion of the tongue 19f that curves around the gear 24 to force the tongue into a curvature at which the teeth 33 of the tongue engage with the teeth 34 of the gear. The end portion of the tongue 19f than slides along another linear tongue guide 74 which extends along the base of housing 21. The motor drives the gear 24 to extend or retract the tongue 19 from the edge of the display screen in accordance with control signals from the electronic apparatus. Clearly, the extent of the fader tongue extending outwardly from the edge into the image area is graphically related to the magnitude of a signal level that is derived from or fed into an electronic device such as a computer.

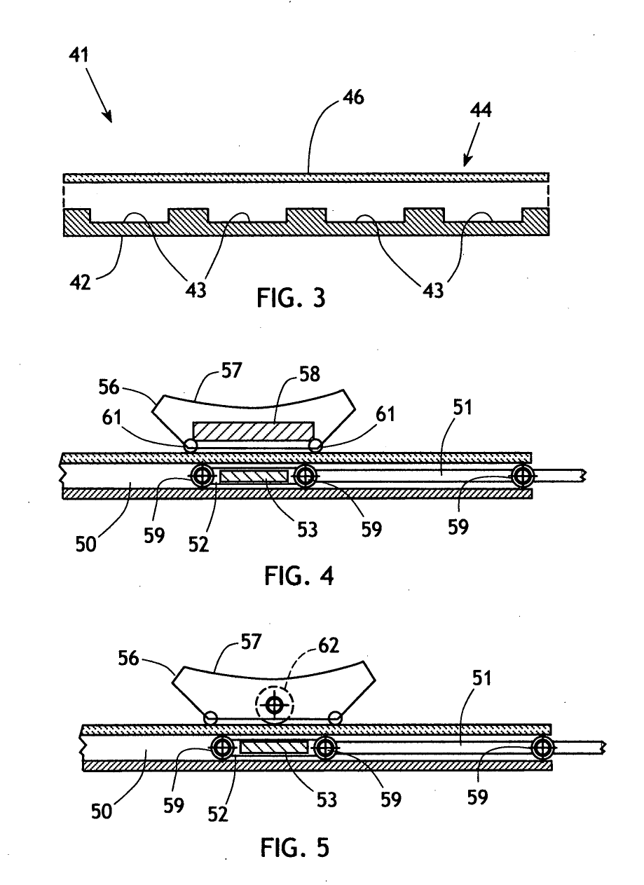

With regard to FIG. 3, one aspect of the invention includes providing an overlay assembly 41 that serves to support a fader tongue and fader cap similar to the prior art, with the salient difference that the fader cap is not mechanically joined to the fader tongue. The overlay assembly 41 includes a base panel 42 formed of a transparent material and having at least one open channel 43 extending from one edge of the base panel in the upper surface thereof. A cover panel 44 is also formed of a transparent material and is provided with sufficient length and breadth to span the base panel 42 and be joined to the upper surface thereof. The cover panel 46 serves to seal the open channels 43 to convert them to closed channels 50 (FIGS. 4 and 5) that are not accessible from the upper surface 47 of the cover panel. Indeed, the upper surface 47 is generally smooth and continuous and free of any channels, tracks, or non-planar features.

As shown in FIG. 4, the channel 50 is dimensioned to receive a fader tongue 51 extending therein and freely movable in the longitudinal direction along the axis of the channel. Tip assembly 52 is joined to the distal end of the tongue 51, and is also dimensioned to translate freely along the channel 50. A magnet 53 is secured in tip assembly 52. The invention includes a fader cap 56 disposed at the outer surface 46 of the overlay and unattached to the fader tongue in any mechanical manner. The fader cap includes an upper surface 57 that is curved to accommodate the fingertip touch of a user. The fader cap 56 supports a magnet 58 therein, and the magnets 53 and 58 are arranged each to present to the other an opposing magnetic polarity, whereby the magnets 53 and 58 are coupled in a maximal manner.

Movement of the fader cap 56 along the axis of the channel 50 is coupled to the fader tongue 51, whereby manual movement of the cap 56 causes the tongue 51 to extend or retract in channel 50. This movement of the tongue is translated into control signals for the electronic apparatus, as will be detailed below.

It is necessary only for the tongue 51 to glide within the channel 50 with sufficient ease to enable the magnetic coupling force from the cap 56 to translate the tongue along the channel. The tip assembly 52 and various portions of the tongue 51 may be provided with fixed glide supports formed of low friction material such as PTFE, Delrin and the like. Likewise, the fader cap 56 may be provided with gliding surfaces or runners formed of low friction material. Alternatively, as shown in FIG. 4, the tip assembly 52 may be provided with two pairs of laterally opposed wheels 59 with pivot axes normal to the longitudinal extent of the channel 50 to minimize the moving friction of the tongue assembly. Likewise, the tongue 51 may be provided with similar wheels 59′ to support the tongue with minimal friction during translation. Similarly, the fader cap 56 may be provided with two pairs of laterally opposed wheels 61 oriented to travel in the longitudinal direction of the fader cap. The wheels 61 not only minimize friction during translation of the fader cap 56, they also add a significant degree of mono-directional travel to the fader cap, so that the fader cap will traverse substantially the same linear travel path when pushed reciprocally back and forth by a user. Thus the wheels 61 aide in maintaining alignment of the fader cap 56 with the channel 50, thus maintaining the magnetic coupling of the cap and the tip assembly 52 of the tongue.

With regard to FIG. 5, the same reference numerals are used as in FIG. 4 for the same components. In this embodiment the fader cap 56 is provided with a cylindrical magnet 62 that is mounted as a roller on the fader cap, with the outer roller surface contacting the outer surface 46 of the overlay assembly. Indeed, any of the wheels 59 or 61 may be replaced by rollers to achieve the same effect. Furthermore, an alternative embodiment of the overlay assembly provides an open gap between the base panel 42 and the cover panel 44, with no defined channels in the gap. The mechanism that operates the fader tongue provides lateral stability to the tongue, and the wheels of the tongue tip assembly provide further longitudinal monodirectionality to the tongue movement. Thus the fader cap moves along the top surface of the cover panel, and the magnetically coupled fader tongue moves longitudinally within the gap beneath the cover panel.

A further embodiment of the fader cap is designed to augment the lateral strength of the magnetic coupling between the fader cap and the fader tongue. Due to the fact that the single magnets described previously in the fader cap and fader tongue exert a primary coupling in the vertical direction (normal to the outer surface of the overlay), there is little coupling in the lateral (shear) direction. Thus there is a possibility that the fader cap will be moved laterally away from the axis of the fader tongue, resulting in decoupling of the magnetic adhesion therebetween and interruption of signal input from the user.

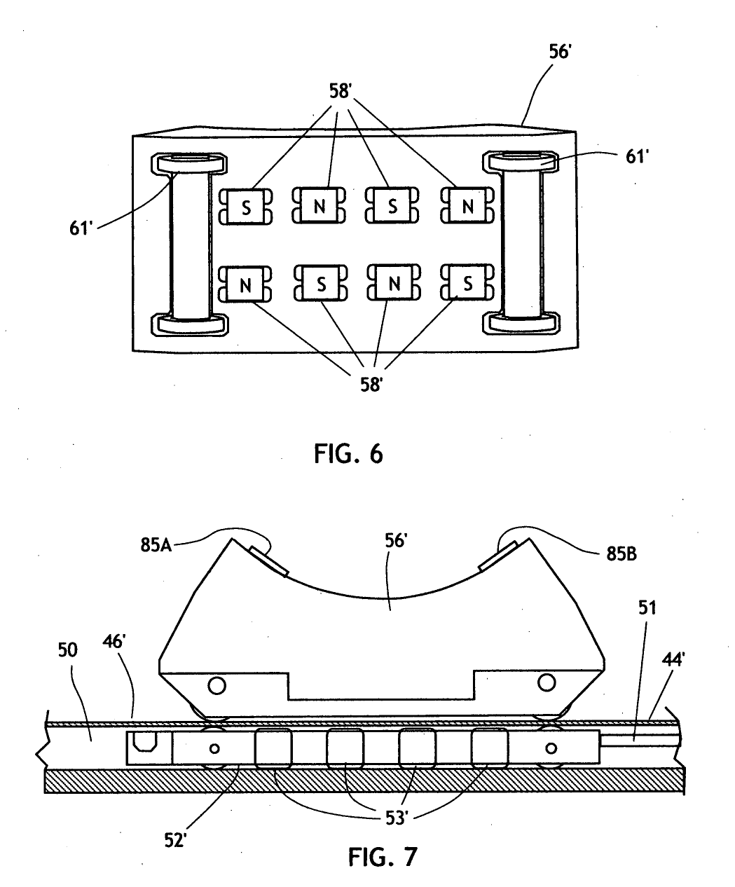

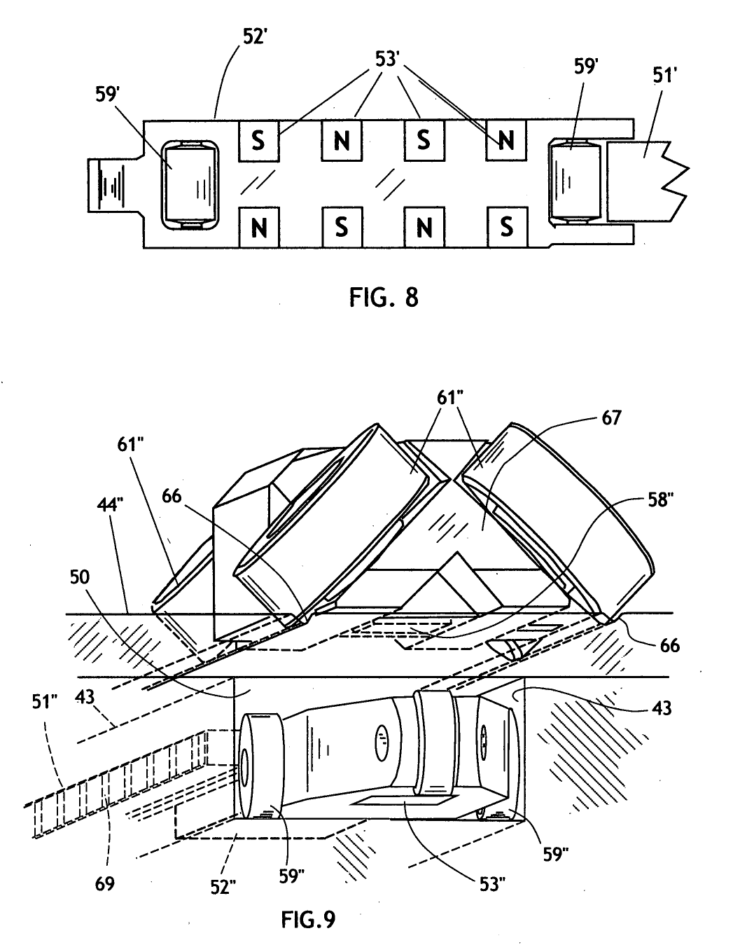

With reference to FIGS. 6-8, components similar to previous embodiments are given the same reference numeral with a prime (′) designation. Fader cap 56′ has the same general shape as depicted previously, with wheels 61′ to allow the cap to roll on the upper surface 46′ of the overlay assembly 41′. Secured in the bottom of the fader cap 56′ is an array of magnets 58′ that presents a predetermined pattern of polarity extending downwardly toward the surface 46′. The tip assembly 52′ is provided with a similar array of magnets 53′ (FIG. 8), except that the polarity pattern is reversed, so that there is maximum magnetic attraction and coupling when the two arrays are directly aligned vertically with only the thin cover panel 44′ separating the magnets. In the illustrated example, the array is a 4×2 matrix with each magnetic pole adjacent to an opposite pole in the Cartesian X/Y directions. Other patterns may be devised that achieve the purposes described herein.

Most significantly, the array of magnets resists lateral misalignment of the fader and fader tongue by exerting a lateral repulsion force when the fader cap begins to move laterally off-axis. If the fader cap begins to drift laterally away from the axis of the channel 50 while it is being translated therealong, the lateral movement will cause one row of the magnets of the fader cap to approach their same-polarity counterpart in the tip assembly 52′. The resulting repulsion force is strong enough to be palpable to the user. Thus the user is urged by the “feel” of the magnetic interaction to push the fader cap generally along the axis of the channel that encloses the fader tongue that is magnetically coupled to the fader cap.

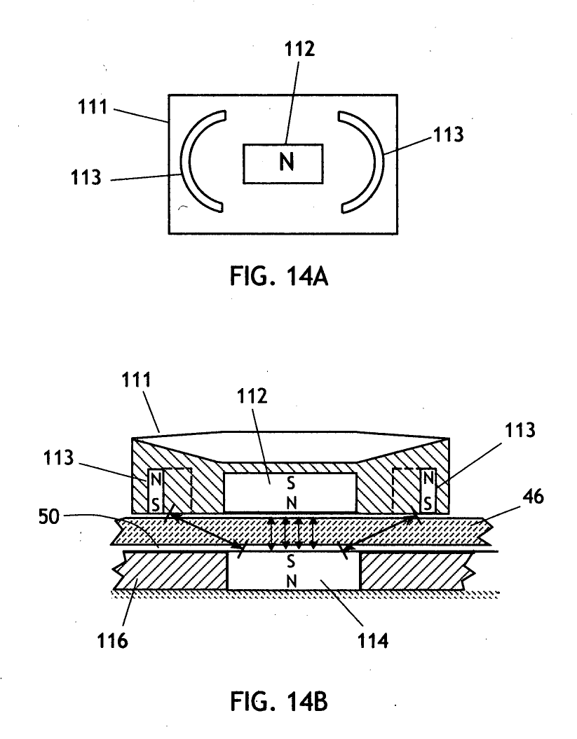

With reference to FIGS. 14A and 14B, another embodiment of the magnetic coupling arrangement includes a fader cap 111 having a central magnet 112 presenting a north pole downwardly. A pair of semi-circular magnets 113 are disposed in diametrically opposed relationship with the magnet 112 medially therebetween. The magnets 113 each have their south pole facing downwardly, as shown in FIG. 14B. A fader tongue 116, similar to the component 51 and its variants, is entrained within closed channel 50 beneath cover panel 46. The tongue 116 supports a magnet 114 having a south pole facing upwardly therefrom. When the fader cap magnet 112 and fader tongue magnet 114 are in vertical registration, their confronting opposite poles creates a strong magnetic coupling effect between the fader cap and fader tongue. In addition, the south poles of the magnets 113 are facing downwardly in confronting relationship to similar south pole of magnet 114, though there is little interaction therebetween when the magnets 112 and 114 are in registration. However, should the magnets 112 and 114 begin to lose registration in the longitudinal direction of the channel 50, the confronting south poles of magnets 113 and 114 exert a repulsion force that favors a restoration of the vertical registration of the magnets 112 and 114. This embodiment illustrates that the magnet structure and arrangement may be designed to enhance the magnetic coupling of the fader cap and tongue. Other such arrangements may be possible and/or desirable. Furthermore, the magnetic polarities described herein may be reversed across the board without affecting the coupling functions.

With regard to FIG. 9, the invention includes a further embodiment designed to align the fader cap travel positively with the channel 50, even though there is no mechanical connection between the fader cap and fader tongue. The cover panel 44″ is provided with a pair of wheel grooves 66 formed in the outer surface 46″ of the cover panel and aligned with a respective closed channel 50 directly therebelow. The grooves 66 are rather shallow and do not penetrate very far into the surface 46″. The fader cap 56″ includes a carriage 67 that supports two pairs of wheels 61″ disposed fore and aft on the carriage and aligned to travel in the longitudinal direction. Notably, the wheels on each side of the carriage are provided with a negative camber at a large angle, and are spaced so that the annular vertex formed by the cylindrical wheel surface and the sidewall thereof is disposed to be received in one of the grooves 66. Thus the wheels 61″ on one side of the carriage are both engaged in the same groove, and the wheels on the other side are engaged in the other groove. This engagement minimizes the trace of the grooves on the surface of the overlay assembly while also maximizing the directional constraints of travel of the fader cap. Indeed, it is difficult to push the fader cap 56″ out of alignment with the channel 50. The carriage 67 supports a magnet 58″ similar to the previous embodiments to magnetically couple with the fader tongue assembly.

The tip assembly 52″ of the fader tongue 51″ includes a pair of laterally opposed wheels 59″ spaced within the lateral confines of the closed channel 50, and a single front wheel 68. Magnet 53″ is secured within tip assembly 52″ to magnetically couple with magnet 58″ so that the fader cap and fader tongue move in concert. Alternatively, both the fader cap and tip assembly may be provided with any of the magnet arrays described herein. Fader tongue 51″ comprises a flexible belt having rack teeth 69 formed on at least one longitudinal side thereof, whereby a motor drive assembly may engage the fader tongue, as will be explained below.

It may be appreciated that the measures described herein for directing the fader cap to remain “tracking” the fader tongue may be employed as needed in designing the apparatus, taking into account the magnetic force of attraction between the fader cap and tongue, the drag caused by friction and other mechanical devices, and the control systems described herein. Likewise, the fader tongue may comprise a flexible belt, or a chain of links designed for easy rolling, such as roller chain or the like, which may be fabricated of transparent or translucent plastic material to maximize visualization of the image content of the electronic display associated with the control system of the invention.

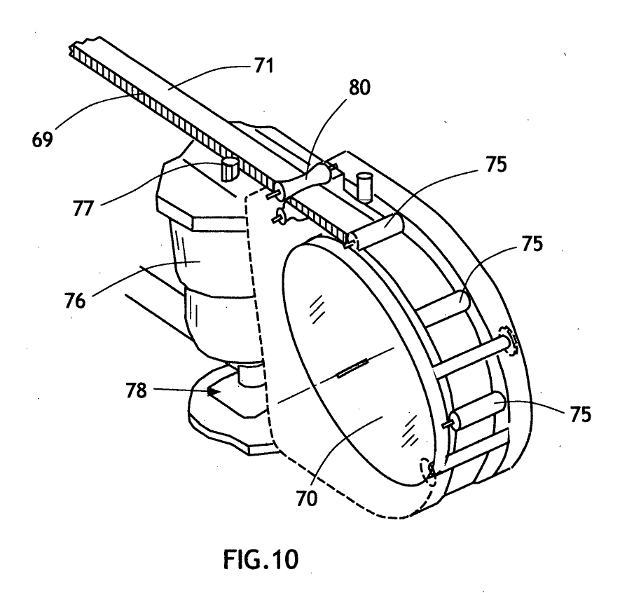

With regard to FIG. 10, the fader tongue in any of the embodiments herein may be implemented as a flexible belt 71 having rack teeth 69 arrayed longitudinally one at least one edge of the belt. The fader tongue drive system is disposed at one edge of the overlay assembly 41 and includes a pulley wheel 72 about which the belt 71 traverses approximately 180°. The belt is held to the pulley wheel by a plurality of flat rollers 75, and a concave idler roller 80 is disposed at the point where the belt 71 breaks contact with the pulley to guide the belt as it extends into the closed channel 50 as described previously. A motor assembly 76 is secured to the housing of the pulley wheel, and the output shaft is provided with a pinion gear 77 that meshes with the rack teeth 69 of the belt 71. The motor assembly may comprise a stepper motor having high incremental resolution, or may comprise some other form of accurate electric motor. This apparatus may employ pressure rollers in place of the rack-and-pinion drive system described above, since rollers are inherently smoother in operation than meshing gear teeth.

In addition, an encoder assembly 78 includes a magnet secured to the shaft of motor assembly 76 of the motor-pulley assembly and a fixed detector adjacent to the encoder magnet that reads the rotations and partial rotations of the motor shaft. In addition, an optical or magnetic linear encoder detects optical or magnetic coding on the belt or on the pulley as it moves to extend or retract the belt 71, and generates a position signal that is scalable to represent the position of the fader tip assembly in the channel 50, and does so with a high degree of resolution. Thus, for example, when the user pushes the fader cap and the magnetically coupled fader tongue is driven along the channel, a stream of position data signals may be generated by the shaft encoder and/or linear encoder. These data may be used by the electronic apparatus as control commands to increase or decrease a variable, such as an audio or video parameter, or a position of an onscreen object, or the like, and/or to alter the display presentation to portray the change in the variable. Likewise, the motor 76 may be driven by the electronic apparatus to move the fader tongue to a preset or memory position, and the fader cap will move with the tongue due to the magnetic coupling therebetween.

Pressure rollers may slip during rapid acceleration of the fader tongue or of the motor drive, and lose correspondence between the actual position of the tongue and the position as read by the shaft encoder of the motor. This problem can be corrected by using the signal of the linear encoder to correct the position data, as described below. The linear encoder may include sensor indicia along the surface of the fader tongue, such as a line array or a dot array or a bar code or a triangle that has its base at the start of the fader tongue and goes to a point at the distal end of the fader tongue. Furthermore, these indicia can be created with a material that is detectable by infrared light but invisible to the human eye so the fader tongue retains its invisible appearance to the naked eye. The linear encoder does not need to have the high resolution of the main fader (shaft) encoder. It may be much coarser, in the range of 250 or 512 points.

Each motorized fader has two encoders, a magnetic encoder and a linear encoder. If the fader is being moved very slowly, there will likely be little or no slippage, so the linear light encoder will not be very useful. However, if the fader is moved very fast or is accelerated rapidly, there may be slippage. In this case a reader can read the nearest position of the linear optical scale deposited along a surface of the fader tongue and use this positioning information to update or correct the positional data of the magnetic encoder which may have slipped a bit due to its pressure rollers losing positive engagement for a split second.

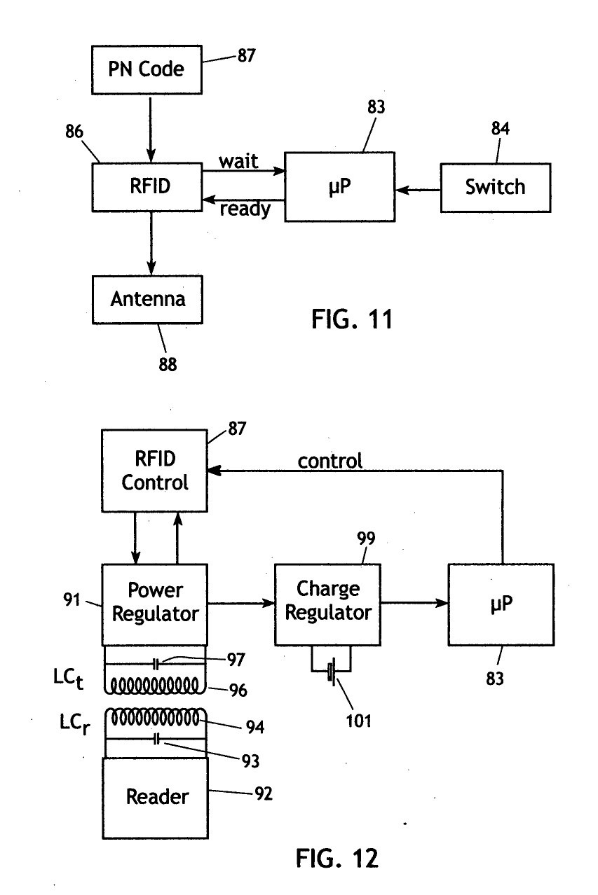

The invention further includes an electronic system that may track the fader tongue position of multiple devices, as well as interact with the fader caps in order to establish a fully functional, fully reconfigurable control system for multiple variables. With regard to FIG. 11, each fader cap 56 or the various embodiments thereof may be provided with an RFID circuit. It includes a μP 83 that is connected to an RFID transmitter circuit 86, which is also connected to a PN code memory 87 (other codes may also be used). The input to μP 83 is a switch 84 that convey at least one single event bit to the RFID circuit 86 (i.e. for M=1). The switch 84 may be a simple SPST switch will detects touch only and sends one PN code sequence.

Alternatively, the switch 84 may provide a SPDT function in which touching one part of the fader cap indicates up/increase/positive, and the other part indicates down/decrease/negative. For example, as shown in FIG. 7, a pair of touch switches 85A and 85B may be supported on the upper surface of the fader cap, so that the user may press on one or the other switch to push the fader cap in either longitudinal direction. In this alternative case, the PN code is transmitted to indicate up/increase/positive touch, and the inverted PN code is transmitted to indicate down/decrease/negative touch. Thus the RFID signal may be used to drive the fader tongue to extend or retract, in response to the user's finger touch on the fader cap, as detailed below.

FIG. 12 depicts the elements of the power circuit of each RFID device in each fader cap. This circuit requires few components and allows for the whole circuit to be powered directly from the RFID reader depending on the RF signal strength. Reader 92 is provided with an antenna circuit comprised of an inductor 94 in parallel with capacitor 93, whereby the LCᵣ factor determines the resonant frequency of the antenna circuit. Each RFID device includes a similar antenna circuit comprised of inductor 96 in parallel with capacitor 97 to produce an LCₜ factor that tunes the RFID antenna circuit to the reader antenna circuit. The RFID antenna circuit is connected to power regulator 91, which in turn delivers power to a charge regulator 99. The power from charge regulator 99 is fed to the μP 83, which powers the μP and causes it to deliver a control signal to the RFID circuit 87. If the combination of the μP and tag circuit cannot be powered as a single unit by the instantaneous power of the reader power signal, then an optional battery 101 (typically a long life lithium, or the like) is connected to the charge regulator to allow for sufficient powering of the μP and analog input component. That is, the battery may be charged when the device is not transmitting, and may accumulate sufficient power to drive the RFID transmission protocol (described above) when necessary.

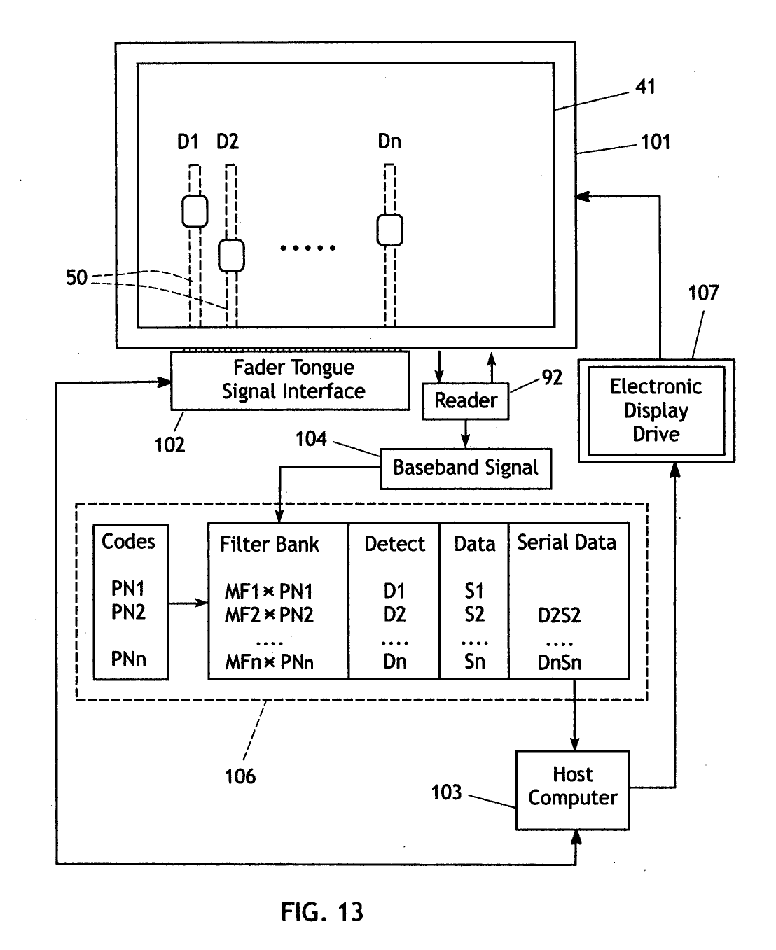

One embodiment of an electronic control system for the invention, shown in FIG. 13, includes the RFID reader 92 disposed to receive signals from a plurality of fader cap RFID devices D₁ - - - Dₙ disposed on overlay assembly 41 in front of an electronic display 101. The system includes a fader tongue signal interface 102 that transmits position data of the fader tongues associated with the fader caps D₁ - - - Dₙ to the host computer 103, and also transmits motor drive signals from the host computer 103 to the motors 76 that translate the fader tongues in their respective channels 50 within the overlay assembly 41.

The reader 92 receives the raw PN code burst from all the devices D1-Dn, and produces a baseband signal 104 that is fed to a CDMA processor 106. The CDMA processor compares the broadband signal to a filter bank of PN codes that contains all the codes of the devices D1-Dn. When code PN1 is fed to the filter bank having stored codes MF1 . . . MFn, it is compared with all the programmed codes until a match with MF1 is found, leading to device D1 being detected. The data content of D1, here termed S1 is derived from the burst. Likewise PN2 is matched against all codes until a match with MF2 is found leading to detection of D2 and derivation of data S2. This process is carried out until code PNn is matched with MFn, and the related data is read. The serial data D2S2 to DnSn is fed from the CDMA processor to the host computer 103, which typically also operates the electronic display associated with the fader controller system. Assuming that the data thus derived identifies all of the devices D1-Dn, the host computer may correlate each fader cap RFID device with a respective fader tongue to which it is magnetically coupled. The host computer 103 updates the display appropriately through the electronic display drive 107 to portray graphically the altered settings of the devices. The RFID data may include the touch signals from the switches 85A-85B, indicating to the host computer which direction the associated fader tongue will be moved. The respective motor assembly may be driven in the indicated direction by the host computer. The advantage of this arrangement is that the user does not need to overcome the resistance of the fader tongue in the covered channel 50 when manually moving the fader cap magnetically coupled to it. The motor overcomes any resistance of the fader tongue in its glass channel, therefore the amount of force that a user needs to assert on the fader cap tends to be constant. This makes for a smoother and more intuitive operation of the fader cap.

The electronic control system described above enables many possible modes of operation that may be programmed into the system and changed as desired by the user. For example, if a user touches a fader cap that is being moved by its magnetically coupled fader tongue and motor, and restrains movement of the fader cap and tongue, the system may detect the difference between where the fader tongue should be and where it actually is. If a user moves the fader cap from a stationary position, the same detection process is carried out by the software. This detection can be very fast, on the order of 1 ms or less. Note that the optical sensor or magnetic encoder described previously reads the movement of the fader tongue and determines there is a discrepancy between the actual fader cap position and the position of the fader tongue that is expected by the system. This “expected” position is the position that is currently saved in the memory of the host computer.

Automation of audio/video controllers is known in the prior art and typically includes a sub-system that is capable of memorizing positions and moves made on any motorized fader and then enabling the automatic playback of those moves. In the present invention, during the playback of these moves, a motor moves the fader tongue in and out of the channel in the cover sheet and this, in turn, moves the fader cap directly above the fader tongue tip assembly due to the magnetic coupling therebetween. When a user moves a fader cap in any direction, the system recognizes that the fader is being moved manually. At that point the system automatically switches to a mode that enables the manual movement of the fader cap and therefore its respective tongue. The system then records the user's manual movements of the fader cap or simply permits manual movements of the fader cap without recording them. Once the user breaks contact with the fader cap, the system again transfers control back to the motor for that fader cap/fader tongue coupled assembly.

Thus, the host computer may store previous controller configurations, such as audio or video mixing devices and settings, so that they may be recalled instantly; e.g., for the purposes of continuity in an editing project. The faders may be configured and labeled accordingly on the display 101, and the fader tongues may be advanced to the stored settings, translating their magnetically coupled fader caps as they advance. Thereafter, the user may manipulate the fader controllers by moving the fader caps on the overlay assembly, moving the fader tongues accordingly and changing the settings of the control functions assigned to the fader controllers. Reconfiguration of the controller setup may be carried out virtually instantaneously.

Thus it may be observed that the invention provides improvements over the state of the art in fader controller design, and exhibits the following advantages:
1) The fader caps float over a smooth unbroken sheet of material, e.g., glass, plastic and other suitable transparent materials or graphite, metal and other opaque or semi-opaque materials. In all cases, no dirt, dust, grease, liquids, etc., can get into the fader tongue because the fader tongue is enclosed inside a material, like glass or plastic. The motor control/position feedback routine enables the drag in fader cap movement to be substantially eliminated, enhancing the “floating” effect of the fader caps.
2) The fader controller may be operated over virtually any flat panel display, whether manufactured for this purpose or not. Thus the flat panel display can be used to provide graphical controls and indicators and indicia for operating the fader, like switches, meters, fader scalings, associated devices, assignments, remote control, automation and more. Furthermore, operating a mechanical fader over a flat panel display permits the fader to be configured in function and scale by changing the graphics displayed on the flat panel display adjacent to the mechanical fader.
3) The fader controller provides a mechanical fader that may be motorized while being operated over a flat panel display.
4) The use of a magnetic or optical encoder permits the fader to have a very high signal resolution. For example, a 9 bit magnetic encoder used for this fader design yields 6000 separate positions per inch. Higher bit rates are available.
5) A large number of these faders can be operated at the same time without cumulative time delays in their real time operation.
6) The fader is inexpensive to build as there are no electrical components in the fader cap (except for the RFID embodiments).
7) Fader caps can be of different colors to designate different operations. Changing fader caps is as easy as placing a new fader cap over any given fader tongue.
8) Fader caps can be removed from the surface of the overlay glass or other suitable material and the fader will still operate via motor control.
9) The fader channels and fader tongues can be transparent so all parts of the fader track and tongue (except for the fader magnet array) can be seen through, for instance, to graphics displayed on a flat panel display below the fader tongues.
10) By having multiple rows of magnets, the amount of the lateral force required to move the fader cap perpendicular to the fader tongue is increased. Three rows of magnets could be used instead of two or even more rows, depending upon the desired amount of force desired to break the coupling between the fader cap's magnet array and fader's tongue's magnet array.
11) Using a single magnet bounded on either end by a curved magnet of an opposing pole can be an equally effective magnet array for the fader cap. A single magnet in the fader tongue of an opposing magnetic pole to the single magnet in the fader cap can provide sufficient magnetic coupling if the magnet is of sufficient strength. Also the curved magnets in the fader cap which have the same pole as the magnet in the tongue are best matched to the strength of that magnet. Finally, the bearings in the fader cap and in the tongue need to be sufficiently fluid to offset the increase in vertical magnetic coupling of the fader cap and fader tongue to prevent an undesirable increase in friction which will impede the smooth motion of the fader cap.

Although the electronic identification and touch recognition functions of the magnetically coupled fader cap have been described herein with reference to an RFID embodiment, it may be appreciated that other wireless communication technologies known in the prior art may be used, such as resonant EMF field transmission, and the like.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. A fader controller for use with an electronic display, including:
an overlay assembly having at least one closed channel extending therein adjacent to an outer surface of said overlay assembly;
at least one fader tongue disposed in said at least one closed channel and translatable therealong to indicate a changeable signal parameter;
at least one fader cap disposed on said outer surface of said overlay assembly and mechanically unconnected to said at least one fader tongue; and,
magnetic coupling means for linking said at least one fader cap and said at least one fader tongue for translation together in the longitudinal direction of said at least one closed channel.

2. The fader controller of claim 1, wherein said magnetic coupling means includes a first magnet disposed in said at least one fader cap and having first and second polarities at opposed ends thereof, with said first polarity facing downwardly from a bottom surface of said fader cap, and a second magnet secured to said at least one fader tongue and having first and second polarities at opposed ends thereof, with said second polarity facing upwardly from an upper surface of second magnet, whereby said first and second magnets are magnetically attracted when disposed in aligned registration.

3. The fader controller of claim 1, wherein said magnetic coupling means includes a first plurality of magnets disposed in said at least one fader cap and having first and second polarities at opposed ends thereof and arrayed in a first pattern of magnetic polarities in a bottom surface of said fader cap, and a second plurality of magnets secured to said at least one fader tongue and having first and second polarities at opposed ends thereof and arrayed in a second pattern of magnetic polarities that is the reverse of said first pattern, whereby said first and second pluralities of magnets are magnetically attracted when disposed in aligned registration and generate substantial lateral repulsive force when moved toward misaligned registration, thus restoring aligned registration.

4. The fader controller of claims 2 or 3, wherein said at least one fader cap includes a first plurality of wheels for supporting said fader cap in low friction translation along said outer surface and for constraining translation in said longitudinal direction.

5. The fader controller of claims 2 or 3, wherein said at least one fader tongue includes a second plurality of wheels for supporting said fader tongue in low friction translation within said closed channel.

6. The fader controller of claim 1, wherein said magnetic coupling means includes a plurality of magnets.

7. The fader controller of claim 1, further including sensor means for detecting the position of said fader tongue extending into said closed channel and generating a position signal having a parameter scaled to said position.

8. The fader controller of claim 7 wherein said overlay assembly includes an edge at which said fader tongue extends into said closed channel, and said sensor means is disposed at said edge.

9. The fader controller of claim 1, wherein said overlay assembly includes an edge at which said fader tongue extends into said closed channel, and further including motor drive means disposed at said edge and engaged with said fader tongue.

10. The fader controller of claim 9, wherein said motor drive means includes a pulley wheel about which said fader tongue is passed, and a motor connected to drive said fader tongue reciprocally about said pulley wheel to extend and retract said fader tongue in said closed channel.

11. The fader controller of claim 10, wherein said motor drive means includes sensor means for detecting the position of said fader tongue extending into said closed channel and generating a signal having a parameter scaled to said position.

12. The fader controller of claim 7, further including touch sensing means on said at least one fader cap to generate a touch signal, RF transmitting means in said at least one fader cap to transmit said touch signal, and a host electronic apparatus to receive said touch signal and receive said position signal from said sensor means and associate the touch signal of a fader cap with its respectively magnetically coupled fader tongue.

13. The fader controller of claim 12, wherein said RF transmitting means includes an RFID device.

14. The fader controller of claim 13, wherein said touch sensing means includes advance and retract sensors, and said RFID device transmits a code pattern to indicate an advance signal and transmits the inverse of said code pattern to indicate a retract signal.

15. The fader controller of claim 14, further including motor drive means connected to said at least one fader tongue and said host electronic apparatus is connected to operate said motor drive means, whereby said host electronic apparatus may operate said fader tongue in automated mode, with said at least one fader cap coupled to and traveling with said at least one fader tongue as it is moved by said motor drive means.

16. The fader controller of claim 15, wherein said advance signal and retract signal may be used by said host electronic apparatus to operate said motor drive means to advance and retract said fader tongue, respectively.

17. The fader controller of claim 13, further including means for transmitting operating power to said RFID device via resonant EMF field means.

18. The fader controller of claim 1, wherein said at least one fader cap includes at least one wheel for supporting said fader cap in low friction translation along said outer surface.

19. The fader controller of claim 18, wherein said outer surface of said overlay assembly includes at least one groove formed therein in the longitudinal direction of said at least one closed channel, said at least one wheel being adapted to engage in said at least one groove and to constrain said at least one fader cap to travel in said longitudinal direction.

20. The fader controller of claim 19, wherein said at least one wheel is cambered at a large negative angle so that the annular vertex formed by the outer cylindrical wheel surface and the sidewall thereof is engaged in said at least one groove.

21. A fader controller for use with an electronic display, including:
an overlay assembly;
at least one fader tongue disposed under said overlay assembly and translatable therealong to indicate a changeable signal parameter;
at least one fader cap disposed on said outer surface of said overlay assembly and mechanically unconnected to said at least one fader tongue; and,
magnetic coupling means for linking said at least one fader cap and said at least one fader tongue for translation together in the longitudinal direction of said fader tongue.

22. The fader controller of claim 21, further including a motor drive means to extend and retract said at least one fader tongue under said overlay assembly.

23. The fader controller of claim 22, further including a shaft encoder connected to said motor drive means to generate a first position signal indicating the position of said at least one fader tongue.

24. The fader controller of claim 23, further including a linear encoder connected to said at least one fader tongue to generate a second position signal indicating the position of said at least one fader tongue.

25. The fader controller of claim 24, further including a host electronic apparatus to receive said first and second position signals and determine the position of said at least one fader tongue by accepting the first signal during slow movement of said at least one fader tongue and ignoring said second signal, and accepting said second signal during rapid movement of said at least one fader tongue and ignoring said first signal.

26. The fader controller of claim 21, wherein said at least one fader cap includes a first plurality of wheels for supporting said fader cap in low friction translation along said outer surface and for constraining translation of said fader cap in said longitudinal direction.

27. The fader controller of claim 21, wherein said at least one fader tongue includes a second plurality of wheels for supporting said fader tongue in low friction translation beneath said overlay assembly and for constraining translation of said fader tongue in said longitudinal direction.
